(19) United States
(12) Patent Application Publication
(10) Pub. No.: US 2004/0267837 A1
(43) Pub. Date: Dec. 30, 2004

(54) System and method for updating network appliances using urgent update notifications

(75) Inventors: Bing Wang, San Jose, CA (US); Anson Lee, Soquel, CA (US); Felipe Albertao, Sunnyvale, CA (US); James Card, Nashua, NH (US); Robert P. Scott, Sunnyvale, CA (US)

Correspondence Address: DARBY & DARBY P.C., P.O. BOX 5257, NEW YORK, NY, 10150-6257, US

(73) Assignee: Nokia Inc., Irving, TX (US)

(21) Appl. No.: 10/611,365

(22) Filed: Jun. 30, 2003

(51) Int. Cl. G06F 12/00

(52) U.S. Cl. 707/203

(57) ABSTRACT

The invention provides a system and method for updating network appliances using urgent update notifications. The network appliances periodically initiates connection to “poll” updates from the update server and the update server collects IP addresses from the connections and updates an IP address log. The update server obtains updates for the network appliances and determines whether a particular update is urgent. When an urgent update is available, the server delivers an urgent update notification (UUN) to each known network appliance through an existing port used for messaging. Each network appliance receives the UUN and distinguishes it from other messages. In response to the UUN, each network appliance automatically connects to the server, obtains the urgent update and installs the urgent update.

### FIELD OF THE INVENTION

The present invention relates to computer network management and, in particular, to maintaining devices in networks.

### BACKGROUND

In recent years, there has been a dramatic upsurge in the popularity of electronic communication in business and home applications. The number of networks and the volume of data continue to increase at a rapid rate. To cope with the ever-increasing demand for faster, more secure and more far-reaching networks, a variety of network appliances are being used to meet these demands.

Network appliances are computing devices that are configured to perform at least one operation related to a network. To maintain effectiveness, network appliances are constantly updated to ensure that they are executing the correct versions of software and are operating with the most current data. Updating software and data is especially important for network appliances that are configured to operate as network protection devices. These network protection devices are typically deployed in a network for protecting against computer viruses and other malicious contents. Since computer viruses can infect the entire Internet in a matter of hours, these network protection devices must have the most currently available definitions of new viruses in order to timely prevent content infected with the viruses from infecting the network.

In an enterprise network, network appliances may be configured to receive updates from a service provider's backend server. Generally, it is not feasible for a backend server to directly deliver updates to network appliances. For example, it is usually difficult for the service provider to deploy an infrastructure to collect host information of all of the network appliances. Also, firewall settings on the enterprise network usually disallow connections to an arbitrary port initiated from outside of local network. As a result, network appliances in a network are typically updated by “pulling” updates from the backend server. Each network appliance periodically initiates a connection with and sends an update request to the backend server. The backend server then responses to the request and provides updates to the network appliance. Updating network appliances in this manner involves a tradeoff between system performance and effectiveness. Setting the update intervals too short causes too much overhead to both the backend server and the network. Setting the update intervals too long compromises the effectiveness and the integrity of the network appliances.

A mechanism that can timely and effectively update network appliances in a network without significantly compromising the performance of the network eludes those skilled in the art.

### SUMMARY

Briefly stated, the present invention is directed to a system and method for updating network appliances using urgent update notifications (UUNs). A server obtains updates for the network appliances and determines whether a particular update is urgent. When an urgent update is available, the server delivers an UUN to each network appliance through an existing port used for messaging by the appliance. Each network appliance receives the UUN and distinguishes it from other messages. In response to the UUN, each network appliance automatically connects to the server, obtains the urgent update, and installs the urgent update.

In one aspect, the invention is directed to a method for updating network appliances. The method determines an urgent update and creates an UUN associated with the urgent update. The method also sends the UUN to the network appliances as special messages and provides the urgent update to the network appliances.

In another aspect, the invention is directed to a method that sends the UUN to the network appliances through an existing port that is dedicated for receiving messages of well-known protocols.

In yet another aspect, the invention is directed to a method for obtaining updates. The method receives a message and, in response to determining that the message includes an UUN associated with an urgent update, immediately establishes a connection with a server. The method also obtains the urgent update from the server and installs the urgent update.

In still another aspect, the invention is directed to a system for managing a network that includes an update server and at least one network appliance. The update server is configured to determine updates and to provide the updates to network appliances. The update servers is also configured to determine an update that is urgent and to send an UUN about the urgent update to each network appliance. Each network appliance is configured to periodically initiate connections with the update server and obtain updates. The network appliance is also configured to receive from the update server an UUN associated with an urgent update and to immediately obtain the urgent updates from the update server.

In still yet another aspect, the invention is directed to a method for an update server to obtain up-to-date IP addresses of network appliances from their periodic update requests.

These and various other features as well as advantages, which characterize the present invention, will be apparent from a reading of the following detailed description and a review of the associated drawings.

### BRIEF DESCRIPTION OF THE DRAWINGS

FIG. 1 illustrates an exemplary network in which the invention may be practiced;

FIG. 2 illustrates a schematic diagram of an update server and a network appliance;

FIG. 3 illustrates exemplary communications that may occur between a network appliance and an update server;

FIG. 4 illustrates an operation flow diagram of an exemplary process for a network appliance to obtain updates;

FIG. 5 illustrates an operation flow diagram of an exemplary process for an update server to handle updates;

FIGS. 6-8 show components of an exemplary environment in which the invention may be practiced; and

FIG. 9 illustrates exemplary communications that may occur for an update server to update a network appliance; according to embodiments of the invention.

### DETAILED DESCRIPTION

In the following detailed description of exemplary embodiments of the invention, reference is made to the accompanied drawings, which form a part hereof, and which are shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined by the appended claims.

Providing timely updates to network appliances in a network is crucial to maintaining the performance and integrity of the network. One approach for delivering updates is to use a “pull” system. Each network appliance in the “pull” system is configured to periodically poll a backend server for updates. If the polling intervals are short, the “pull” system can deliver updates with only a small delay. However, the updates are still not immediately delivered and the short polling intervals cause undue overhead on the backend server and the network.

Thus, the present invention is directed to a system and method for updating network appliances using urgent update notifications. A server is configured to obtain updates for the network appliances and to determine whether a particular update is urgent. Each network appliance is configured with an update process that is embedded into an existing messaging daemon. The embedded update process utilizes the same well-known message port that is used by the messaging daemon and does not require the opening of a new message port. Thus, even if a network appliance is protected by a firewall, the firewall would not have to be reconfigured to open a new port to accommodate the UUNs. For example, if a network appliance is used as an email gateway, the network appliance would include a SMTP front-end daemon as the messaging daemon and messaging port would be port 25, which is dedicated for email traffic.

When an urgent update is available, the server delivers an urgent update notification (UUN) to each network appliance using the message port. Each network appliance receives the UUN and distinguishes it from other messages. In response to the UUN, each network appliance automatically connects to the server, obtains the urgent update, and installs the urgent update.

The network appliances may also be configured to periodically poll the server for updates. Because of the use of UUNs, the polling intervals may be set to a large value. The server may also obtain IP addresses of the network appliances when they connect to poll the server for updates, which frees the service provider from deploying complicated infrastructure to collect and maintain IP addresses of customer appliances. The use of UUNs and long update polling intervals enable the network appliances to obtain timely updates without causing unnecessary overhead to the backend server, the network appliances and the network. These and other aspects of the invention will become apparent after reading the following detailed description.

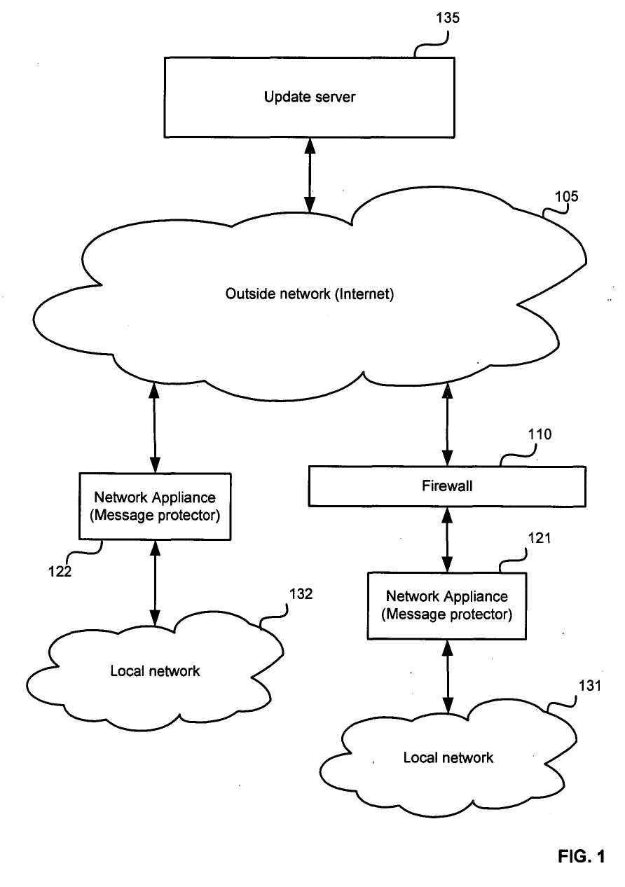

FIG. 1 illustrates an exemplary network in which the invention may be practiced, according to one embodiment of the invention. Outside network 105 may be any type of wide area network, such as the Internet. Local network 131-132 can be any type of network, such as a LAN, special business-orientated enterprise network, and the like. Network appliances 121-122 are connected to local networks 131-132, respectively. In this embodiment, network appliances 121-122 are implemented as message protectors, which are configured to detect and remove exploits from messages. Local network 131 is protected by network appliance 121 configured behind a firewall 110. Firewall 110 is a system configured to prevent unauthorized access to or from a private network. Firewall 110 may pass some data, such as email messages, through network appliance 121 for detecting and removing exploits. Local network 132, which is configured without a firewall, is protected by network appliance 122.

Update server 135 is typically implemented as a backend server on a service provider's network. Update server 135 and network appliances 121-122 may be connected through outside network 105. As shown in the figure, update server 135 may connect to local network 131 through firewall 110. Update server 135 is configured to determine updates for network appliance 121-122. Update server 135 may also be configured to determine which updates are urgent and to notify network appliances 121-122 of the urgent updates using urgent update notifications (UUNs).

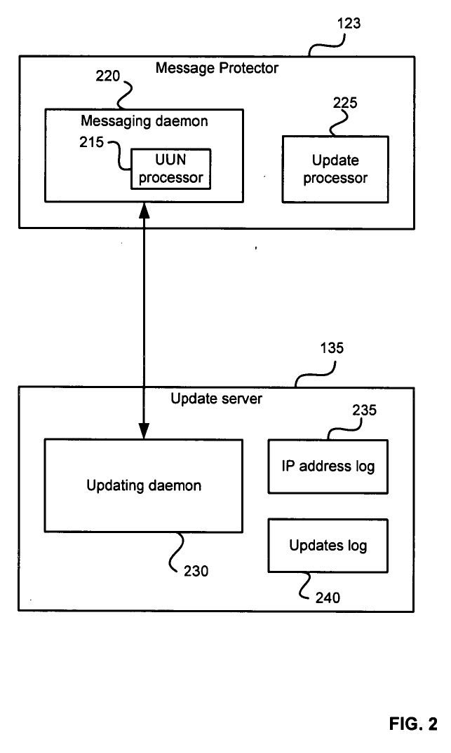

FIG. 2 illustrates a schematic diagram of an update server and a network appliance, according to one embodiment of the invention. As shown in the figure, message protector 123 includes a messaging daemon 220 for processing messages. Message daemon 220 may receive messages through a well-known message port. In this embodiment of the invention, the message port is port 25 for SMTP email messages. For a network appliance that is configured to protect message of another protocol, the message port would be the port dedicated to that protocol, such as port 80 for HTTP traffic.

Message daemon 220 may include UUN processor 215 that is configured to receive and handle urgent update notifications (UUNs) for message protector 123. A UUN is a message sent by update server 135 to notify message protector 123 of an urgent update. A UUN may be configured with a special format to distinguish it from normal messages. Special formats may include a special header, a special subject line, special contents in the body of a message, and the like. A UUN may include information about the urgent update.

UUN process 215 is a component of message daemon 220 and is configured to distinguish an UUN from regular messages by detecting the special format of the UUN. When an UUN is identified, UUN process is configured to send the UUN to update processor 225 or to directly invoke update processor 225.

Update processor 225 is configured to obtain updates for message protector 123. Update processor 225 may connect to update server 135 to obtain updates periodically at pre-determined intervals or in response to a UUN. Update processor 225 may respond to an UNN by automatically connecting to update server 135, obtaining the urgent update associated with the UUN, and installing the urgent update. Update processor 225 may obtain and install only the urgent update or all available updates.

Update server 135 is configured to update one or more network appliances in a network. Update server 135 includes update daemon 230 for handling processes related to updating network appliances. Updating daemon 230 is configured to determine updates for network appliances and to record the updates in update log 240. In normal operations, update daemon 230 periodically receives update requests from message protector 123. For example, message protector 123 may connect to update server 123 to obtain updates after a pre-determined interval has passed since obtaining the last updates. In response, update daemon 230 provides the updates in update log 240 that affect message protector 123.

Update daemon 230 is configured to collect the IP addresses of network appliances that have connected to it for updates and store them into IP address log 235. The IP addresses may also be cached by update server 135 for performance reasons. Update daemon is also configured to remove from the IP address log 235 the IP addresses that are out-of-date. Obtaining and maintaining IP addresses in this manner enables update server 135 to maintain up-to-date IP addresses of network appliances without deploying a complicated infrastructure to collect the IP addresses.

To provide a more effective updating mechanism, updating daemon 230 is also configured to determine which updates are urgent. For an urgent update, updating daemon 230 notifies network appliances that are affected by the urgent update. Updating daemon 230 is configured to send a UUN to each of the affected network appliances. Since the UUN is just a message with a special format such as a special header, the UUN may be directly sent to message protector 123 through the regular message port used by message daemon 220. Thus, even if message protector 123 is protected by a firewall, the firewall would not have to be reconfigured to open a new port to accommodate the UUNs.

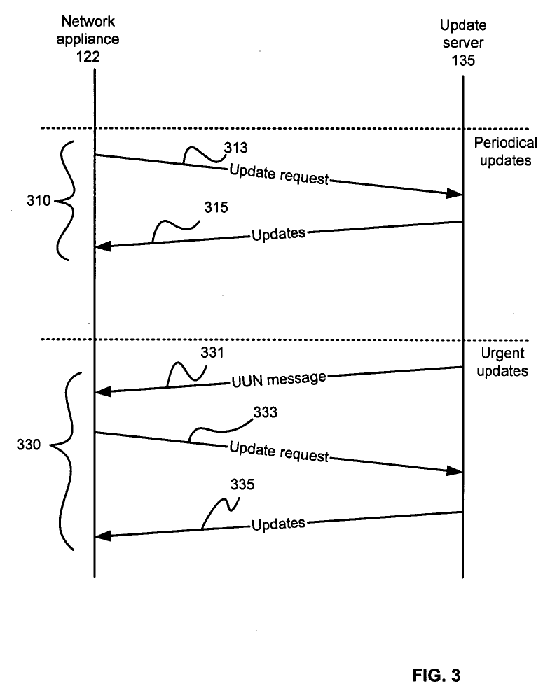

FIG. 3 illustrates exemplary communications that may occur between a network appliance and an update server, according to one embodiment of the invention. The exemplary communication includes communications 310 for periodic updates and communications 330 for urgent updates. Communications 310 are triggered after a pre-determined interval since the last update has passed. Network appliance 122 initiates by sending an update request 313 to update server 135. Network appliance 122 may send the update request 313 by connecting to update server 135. In response, update server 135 provides updates 315 to network appliance 122. Updates 315 may only include updates that affect network appliance 122. Instead of providing updates 315 to network appliance 122, updating server 135 may enable network appliance 122 to obtain an update log that includes updates 315.

Communications 330 are triggered after update server 315 has determined an urgent update. Update server 315 sends a UUN to network appliance 122 through an existing message port. In response, network appliance 122 sends an update request 333 by connecting to update server 135. Update request 333 may be a normal request or a special request that only asks for the urgent update associated with the UUN. In response, update server 135 provides updates 335 that include the urgent update to network appliance 122.

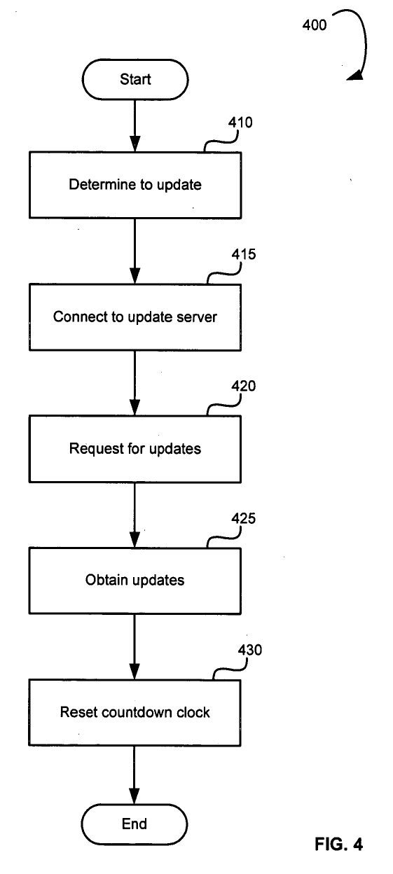

FIG. 4 illustrates an operation flow diagram of an exemplary process for a network appliance to obtain updates, according to one embodiment of the invention. Moving from a start block, process 400 goes to block 410 where a determination is made to update. The network appliance may determine to update in the course of normal operation or in response to an urgent update. In normal operation, network appliance may follow an update schedule with pre-determined update intervals. The network appliance may initiate the update process when it has counted down to the time for updating. For an urgent update, network appliance may automatically initiate the update process after receiving a UUN from an update server.

At block 415, a connection to the update server is established. Typically, the update server is implemented as a backend server and the network appliance may connect to the update server through the Internet. At block 420, the network appliance sends a request for update to the update server. The request may include a request for all updates or for only an urgent update. At block 425, network appliance obtains updates from the update server. The updates may be included in an update log. In another embodiment, the update server may be configured to actively send the updates to the network appliance. At block 430, the countdown clock for updating in the network appliance may be reset and restarted and the process ends. In another embodiment of the invention, the countdown clock is reset only if the update is not triggered by a UUN.

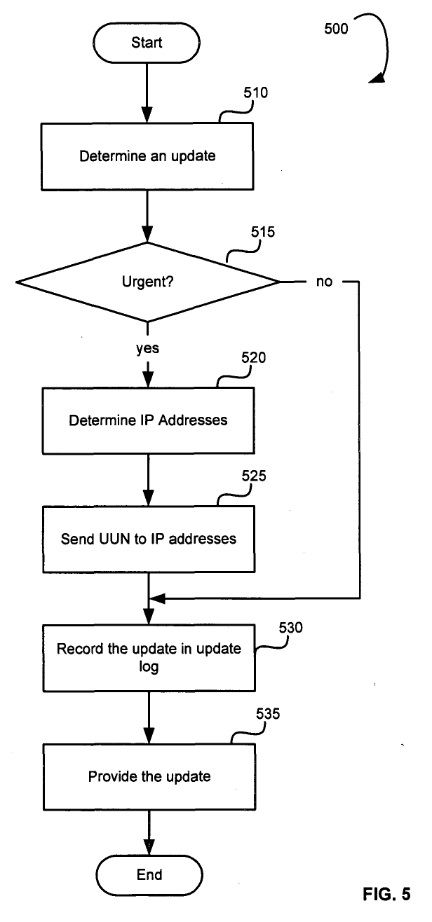

FIG. 5 illustrates an operation flow diagram of an exemplary process for an update server to handle updates, according to one embodiment of the invention. Moving from a start block, process 500 goes to block 510 where an update is determined. At decision block 515, a determination is made whether the update is an urgent update. If the update is not an urgent update, process 500 continues at block 530.

Returning to decision block 515, if the update is an urgent update, process 500 goes to block 520 where the IP addresses of network appliances that are affected by the urgent update are determined. The IP addresses may be obtained from the IP address log. At block 525, UUNs associated with the urgent update are created and sent to the determined IP addresses. Each UUN is a message with a special header or other special formats that distinguish it from normal messages and is sent through the message port of each network appliance.

At block 530, the update is recorded in an update log. At block 535, the update server provides the update to the network appliances. The update server may enable the network appliances to obtain the update from an update log. The update server may also be configured to send the update to the network appliances. The process then ends.

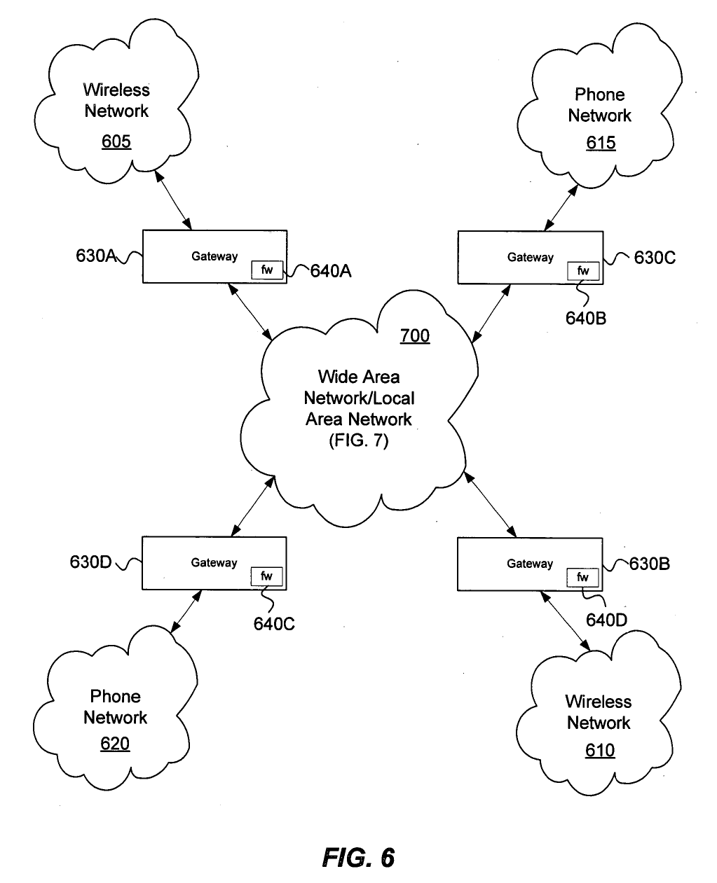

FIGS. 6-8 show components of an exemplary environment in which the invention may be practiced. Not all the components may be required to practice the invention, and variations in the arrangement and type of the components may be made without departing from the spirit or scope of the invention.

FIG. 6 shows wireless networks 605 and 610, telephone phone networks 615 and 620, interconnected through gateways 630A-630D, respectively, to wide area network/local area network 700, according to one embodiment of the invention. Gateways 630A-630D each optionally include a firewall component, such as firewalls 640A-640D, respectively. The letters FW in each of gateways 630A-630D stand for firewall.

Wireless networks 605 and 610 transports information and voice communications to and from devices capable of wireless communication, such as such as cell phones, smart phones, pagers, walkie talkies, radio frequency (RF) devices, infrared (IR) devices, CBs, integrated devices combining one or more of the preceding devices, and the like. Wireless networks 605 and 610 may also transport information to other devices that have interfaces to connect to wireless networks, such as a PDA, POCKET PC, wearable computer, personal computers, multiprocessor systems, microprocessor-based or programmable consumer electronics, network PCs, and other properly-equipped devices. Wireless networks 605 and 610 may include both wireless and wired components. For example, wireless network 610 may include a cellular tower (not shown) that is linked to a wired telephone network, such as telephone network 615. Typically, the cellular tower carries communication to and from cell phones, pagers, and other wireless devices, and the wired telephone network carries communication to regular phones, long-distance communication links, and the like.

Similarly phone networks 615 and 620 transport information and voice communications to and from devices capable of wired communications, such as regular phones and devices that include modems or some other interface to communicate with a phone network. A phone network, such as phone network 620, may also include both wireless and wired components. For example, a phone network may include microwave links, satellite links, radio links, and other wireless links to interconnect wired networks.

Gateways 630A-630D interconnect wireless networks 605 and 610 and telephone networks 615 and 620 to WAN/LAN 700. A gateway, such as gateway 630A, transmits data between networks, such as wireless network 605 and WAN/LAN 700. In transmitting data, the gateway may translate the data to a format appropriate for the receiving network. For example, a user using a wireless device may begin browsing the Internet by calling a certain number, tuning to a particular frequency, or selecting a browsing feature of the device. Upon receipt of information appropriately addressed or formatted, wireless network 605 may be configured to send data between the wireless device and gateway 630A. Gateway 630A may translate requests for web pages from the wireless device to hypertext transfer protocol (HTTP) messages which may then be sent to WAN/LAN 200. Gateway 630A may then translate responses to such messages into a form compatible with the wireless device. Gateway 630A may also transform other messages sent from wireless devices into message suitable for WAN/LAN 700, such as email, voice communication, contact databases, calendars, appointments, and other messages.

Before or after translating the data in either direction, the gateway may pass the data through a firewall, such as firewall 640A, for security, filtering, or other reasons. A firewall, such as firewall 640A, may include or send messages to a network appliance that is configured to detect exploits.

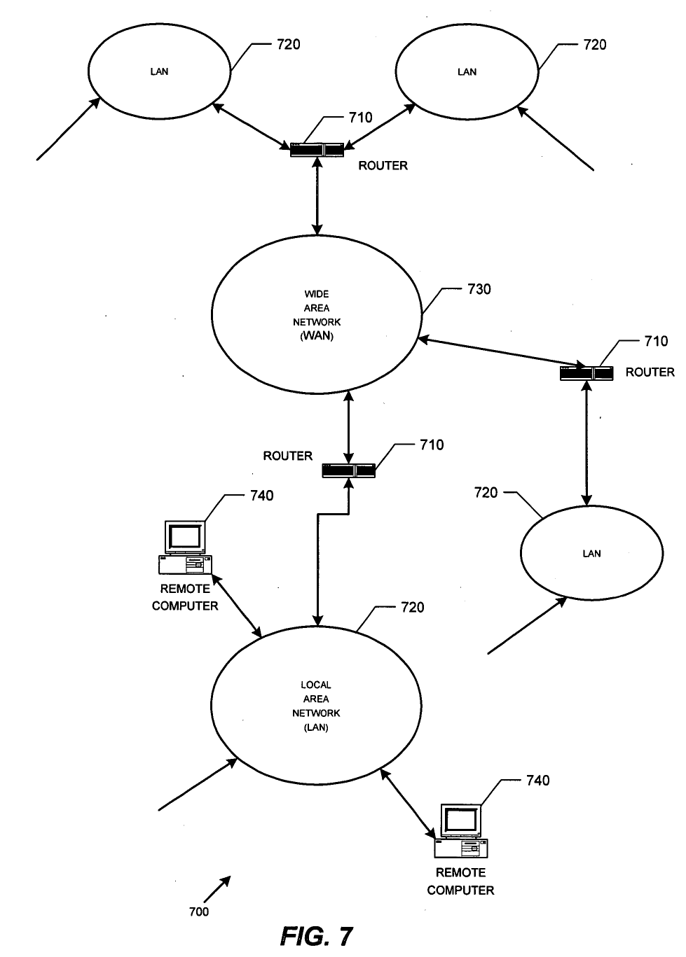

Typically, WAN/LAN 700 transmits information between computing devices as described in more detail in conjunction with FIG. 7. One example of a WAN is the Internet, which connects millions of computers over a host of gateways, routers, switches, hubs, and the like. An example of a LAN is a network used to connect computers in a single office. A WAN may be used to connect multiple LANs.

It will be recognized that the distinctions between WANs/LANs, phone networks, and wireless networks are blurring. That is, each of these types of networks may include one or more portions that would logically belong to one or more other types of networks. For example, WAN/LAN 700 may include some analog or digital phone lines to transmit information between computing devices. Phone network 620 may include wireless components and packet-based components, such as voice over IP. Wireless network 605 may include wired components and/or packet-based components. Network means a WAN/LAN, phone network, wireless network, or any combination thereof.

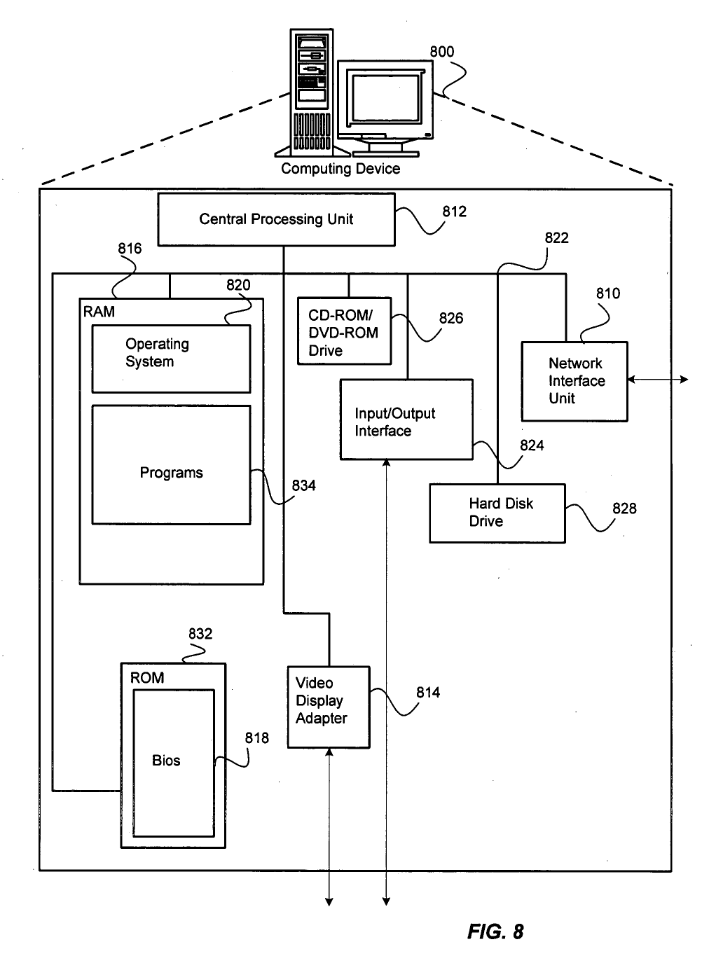

FIG. 7 shows a plurality of local area networks (“LANs”) 720 and wide area network (“WAN”) 730 interconnected by routers 710, according to one embodiment of the invention. Routers 710 are intermediary devices on a communications network that expedite packet delivery. On a single network linking many computers through a mesh of possible connections, a router receives transmitted packets and forwards them to their correct destinations over available routes. On an interconnected set of LANs—including those based on differing architectures and protocols—, a router acts as a link between LANs, enabling packets to be sent from one to another. A router may be implemented using special purpose hardware, a computing device executing appropriate software, such as computing device 800 as described in conjunction with FIG. 8, or through any combination of the above.

Communication links within LANs typically include twisted pair, fiber optics, or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links, or other communications links known to those skilled in the art. Furthermore, computers, such as remote computer 740, and other related electronic devices can be remotely connected to either LANs 720 or WAN 730 via a modem and temporary telephone link. The number of WANs, LANs, and routers in FIG. 7 may be increased or decreased arbitrarily without departing from the spirit or scope of this invention.

As such, it will be appreciated that the Internet itself may be formed from a vast number of such interconnected networks, computers, and routers. Generally, the term “Internet” refers to the worldwide collection of networks, gateways, routers, and computers that use the Transmission Control Protocol/Internet Protocol (“TCP/IP”) suite of protocols to communicate with one another. At the heart of the Internet is a backbone of high-speed data communication lines between major nodes or host computers, including thousands of commercial, government, educational, and other computer systems, that route data and packets. An embodiment of the invention may be practiced over the Internet without departing from the spirit or scope of the invention.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media such as twisted pair, coaxial cable, fiber optics, wave guides, and other wired media and wireless media such as acoustic, RF, infrared, and other wireless media.

FIG. 8 shows a computing device, according to one embodiment of the invention. Such a device may be used, for example, as a server, workstation, network appliance, router, bridge, firewall, exploit detector, gateway, and/or as a traffic management device. The transactions may take place over the Internet, WAN/LAN 700, or some other communications network known to those skilled in the art.

It will be appreciated that computing device 800 may include many more components than those shown in FIG. 8. However, the components shown are sufficient to disclose an illustrative environment for practicing the present invention. As shown in FIG. 8, computing device 800 may be connected to WAN/LAN 700, or other communications network, via network interface unit 810. Network interface unit 810 includes the necessary circuitry for connecting computing device 800 to WAN/LAN 700, and is constructed for use with various communication protocols including the TCP/IP protocol. Typically, network interface unit 810 is a card contained within computing device 800.

Computing device 800 also includes processing unit 812, video display adapter 814, and a mass memory, all connected via bus 822. The mass memory generally includes random access memory (“RAM”) 816, read-only memory “ROM”) 832, and one or more permanent mass storage devices, such as hard disk drive 828, a tape drive (not shown), optical drive 826, such as a CD-ROM/DVD-ROM drive, and/or a floppy disk drive (not shown). The mass memory stores operating system 820 for controlling the operation of computing device 800. It will be appreciated that this component may comprise a general-purpose operating system including, for example, UNIX, LINUX™, or one produced by Microsoft Corporation of Redmond, Washington. Basic input/output system “BIOS”) 818 is also provided for controlling the low-level operation of computing device 800. The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device. The mass memory may store applications including programs 834.

Computing device 800 may also comprise input/output interface 824 for communicating with external devices, such as a mouse, keyboard, scanner, or other input devices not shown in FIG. 8. In some embodiments of the invention, computing device does not include user input/output components. For example, computing device 800 may or may not be connected to a monitor. In addition, computing device 800 may or may not have video display adapter 814 or input/output interface 824. For example, computing device 800 may implement a network appliance, such as a router, gateway, traffic management device, etc., that is connected to a network and that does not need to be directly connected to user input/output devices. Such a device may be accessible, for example, over a network.

Computing device 800 may further comprise additional mass storage facilities such as optical drive 826 and hard disk drive 828. Hard disk drive 828 is utilized by computing device 800 to store, among other things, application programs, databases, and program data The various embodiments of the invention may be implemented as a sequence of computer implemented steps or program modules running on a computing system and/or as interconnected machine logic circuits or circuit modules within the computing system. The implementation is a matter of choice dependent on the performance requirements of the computing system implementing the invention. In light of this disclosure, it will be recognized by one skilled in the art that the functions and operation of the various embodiments disclosed may be implemented in software, in firmware, in special purpose digital logic, or any combination thereof without deviating from the spirit or scope of the present invention.

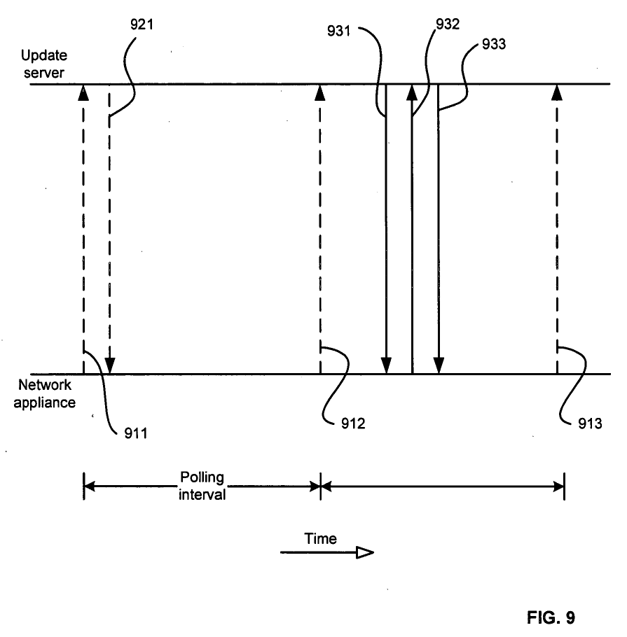

FIG. 9 illustrates exemplary communications that may occur for an update server to update a network appliance, according to one embodiment of the invention. The network appliance may periodically poll the update server for updates. Communications 911-913 represent update requests sent by the network appliance to the update server for this purpose. If updates are available, the update server sends updates to the network appliance as a response in the same connection. Communication 921 illustrates this type of updates. The update server may also notify the network appliance of an urgent update. To achieve this, the update server may send to the client communication 931 that includes a UUN about the urgent update. In response, the network appliance may send communication 932 that includes a request for updates. The update server may then send communication 933 that includes the urgent update as a response in the same connection.

The above specification, examples and data provide a complete description of the invention. Since many embodiments of the invention can be made without departing from the spirit and scope of the invention, the invention resides in the claims hereinafter appended.

What is claimed is:

1. A method for updating network appliances, comprising:
determining an urgent update;
creating an urgent update notification (UUN) associated with the urgent update;
sending the UUN to the network appliances as messages; and
providing the urgent update to the network appliances.

2. The method of claim 1, wherein sending the UUN to the network appliances as messages further comprises sending the messages through specific message ports of the network appliances.

3. The method of claim 1, wherein at least one of the network appliances is a message protector configured to protect messages of a specific protocol, and wherein at least one of the messages is conformed to that specific protocol and at least one of the message ports is dedicated to that protocol.

4. The method of claim 3, wherein at least one of the messages is a SMTP conformed message and at least one of the message ports is port 25.

5. The method of claim 1, wherein each message includes a special format that distinguishes it from normal messages.

6. The method of claim 3, wherein the special format includes at least one of a special header, a special subject line, and special content in the body of the message.

7. The method of claim 1, wherein providing the urgent update to the network appliances comprises enabling the network appliances to obtain a log that includes the urgent update.

8. The method of claim 1, wherein further comprising:
collecting the IP addresses of the network appliances when the network appliances establish a connection to obtain updates; and
storing the IP addresses in a log.

9. The method of claim 8, wherein further comprising removing out-of-date IP addresses from the log.

10. The method of claim 9, wherein sending the UUN to the network appliances comprises sending a message with the UUN to each IP address in the log.

11. The method of claim 10, wherein the IP address is up-to-date.

12. The method of claim 1, wherein the method is operable on at least one of a server, a network appliance, and a dedicated platform.

13. A method for obtaining updates, comprising:
receiving a message;
in response to determining that the message includes an UUN associated with an urgent update,
immediately establishing a connection with a server;
obtaining the urgent update from the server; and
installing the urgent update.

14. The method of claim 13, wherein the message conforms to a specific protocol and is received through a message port dedicated to that protocol.

15. The method of claim 14, wherein the protocol includes a SMTP protocol and the message port includes port 25.

16. The method of claim 13, wherein the message includes a special format that distinguishes it from normal messages.

17. The method of claim 16, wherein determining that the message includes a UUN comprises detecting the special format.

18. The method of claim 16, wherein obtaining the urgent update from the server comprises obtaining a log that includes the urgent update.

19. The method of claim 16, further comprising obtaining updates from the server at pre-determined intervals.

20. The method of claim 1, wherein the method is operable on at least one of a server, a network appliance, a router, a switch, and a firewall.

21. A system for managing a network, comprising:
an update server configured to determine updates and to provide the updates to network appliances, the update servers being further configured to determine an update that is urgent and to send an UUN about the urgent update to each network appliance;
a network appliance configured to periodically obtain updates from the update server, the network appliance being further configured to receive from the update server an UUN associated with an urgent update and to immediately obtain the urgent updates from the update server.

22. The system of claim 21, wherein the update server is further configured to collect IP addresses of the network appliances in conjunction with periodic update requests, store the IP addresses in a log, and remove an IP address from the log when the IP address is out-of-date.

23. The system of claim 21, wherein the update server is further configured to send the UUN as a message to each network appliance through a specific message port.

24. The system of claim 21, wherein the update server is further configured to enable the network appliances to connect to the update server and to obtain updates.

25. The system of claim 24, wherein the update server is further configured to determine IP addresses associated with the network appliances when the network appliances connect to the update server for updates.

26. The system of claim 25, wherein the update server is further configured to send the UUN to the IP addresses.

27. The system of claim 21, wherein the update server is further configured to maintain a log that includes the updates.

28. The system of claim 21, a network appliance configured to access the log to obtain the updates.

29. An apparatus for providing updates to network appliances, comprising:
means for determining an urgent update;
means for creating an UUN associated with the urgent update;
means for collecting and maintaining IP addresses of the network appliances;
means for sending the UUN to the network appliances as messages; and
means for providing the urgent update to the network appliances.

30. An apparatus for obtaining updates, comprising:
means for receiving a message;
means for determining when the message includes an UUN associated with an urgent update,
means for establishing a connection with a server in response to when;
means for obtaining the urgent update from the server; and
means for installing the urgent update.
